(19) United States
(12) Patent Application Publication
(10) Pub. No.: US 2017/0206503 A1
(43) Pub. Date: Jul. 20, 2017

(54) Computerized Systems and Methods for a Dynamic Career Management Platorm

(71) Applicant: Patheer Inc., Quincy, MA (US)

(72) Inventors: Dennis HARRIS, Quincy, MA (US); Matthew HARRIS, Quincy, MA (US); Kevin HARRIS, Quincy, MA (US); Akash SAVDHARIA, Quincy, MA (US)

(73) Assignee: Pantheer Inc., Quincy, MA (US)

(21) Appl. No.: 15/406,080

(22) Filed: Jan. 13, 2017

Related U.S. Application Data
(60) Provisional application No. 62/279,255, filed on Jan. 15, 2016.

(51) Int. Cl. G06Q 10/10; G06F 17/27; G06F 17/30

(52) U.S. Cl. CPC G06Q 10/1053; G06F 17/30684; G06F 17/2785; G06F 17/2705

(57) ABSTRACT

The techniques described herein provide for a career management platform accessed by users (e.g., employees) through many mediums to help them manage and navigate their careers, skills, and/or experiences. The platform allows users to discover other potential opportunities that they may be interested in, provide relevant resources, and provide a means to gain experiences to help close various skills gaps and/or develop vital skills related to their current career, selected career destination, and/or defined career goals (purpose) statement. In one embodiment, opportunities are recommended to the user through the career management platform.

### RELATED APPLICATIONS

This application claims priority to U.S. Provisional Patent Application No. 62/279,255, filed Jan. 15, 2016, which is hereby incorporated by reference herein in its entirety.

### TECHNICAL FIELD

Disclosed apparatus, systems, and computerized methods relate generally to a dynamic career management platform.

### BACKGROUND

There are a few existing systems that help users with career guidance, navigation, and development, examples include LinkedIn, Monster. They typically provide users with recommendations based on what others did to get into a specific career, for example Database Administrator. They then provide users with recommendations on how to improve chances of obtaining that specific position, for example, acquire Java or get a Masters degree or get certain work experience. In order to get these recommendations, users must supply the system with a parameter: what position/career the user wants to get into, e.g. what is your career goal/destination? This is where these particular systems fall short. Such systems fail to recognize that users may not have a goal or a destination in mind, and user goals (or purposes) might not be centered on their next position or even a career at all, but on other general development goals, which may or may not have an effect on their career. For example, a user may just like to improve interaction and collaboration with colleagues, even though their current career, specified career destination, and/or specified career goal (or purpose) statement does not require an improvement in this area. In addition, such systems fail to provide recommendations or a means to obtaining work experience that may be lacking on one's resume. Furthermore, job markets, companies, and technologies are changing so rapidly that users aren't fully aware of the new opportunities that may exist for their particular skillsets, interests, and background. The users also might not fully understand what opportunities are best for them. In addition, they are not aware of the development and experience they need to best position their career for the future. This ultimately limits their full potential.

### SUMMARY OF THE DISCLOSURE

In one embodiment, techniques disclosed herein may be realized as a system for facilitating career, skill, and experience management such that a career recommendation can be automatically recommended to a user. The system may comprise one or more computer processors executing instructions configured to cause the one or more processors to store, in a database in communication with the one or more processors, data indicative of at least one skill that a user has obtained and at least one experience that the user has obtained. The one or more computer processors may further be configured to receive a statement of the user. The statement may comprise an objective that the user wants to achieve. The one or more computer processors may further be configured to determine, using a semantic analysis, that the statement comprises a goal of the user to improve a skill, an experience, or both. The semantic analysis may comprise decomposing the statement into one or more search terms. The one or more computer processors may further be configured to query the at least one skill that the user has obtained, the at least one experience that the user has obtained, or both. The one or more computer processors may further be configured to determine a recommendation in response to the user's goal. The recommendation may be determined based on the at least one skill that the user has obtained, the at least one experience that the user has obtained, or both. The one or more computer processors may further be configured to provide the recommendation to the user.

In accordance with other aspects of this embodiment, the one or more processors may further be configured to determine that the statement comprises a user's desire for a career advancement. The one or more computer processors may further be configured to identify a job that the user follows. The one or more computer processors may further be configured to identify a gap between skills and experiences desired by the job and skills and experiences that the user has obtained. The one or more computer processors may further be configured to provide a recommendation to the user's desire based at least partially on the identified gap.

In another embodiment, techniques disclosed herein may be realized a system for facilitating career, skill, and experience management. The system may comprise one or more computer processors executing instructions configured to cause the one or more processors to store, in a database in communication with the one or more processors, data indicative of at least one skill that a user has obtained, at least one experience that the user has obtained, and at least a job has been posted to the system. The one or more computer processors may further be configured to extract, via a parser, a skill, an experience, or both, desired by the job. The one or more computer processors may further be configured to determine that the job matches the at least one skill that a user has obtained, the at least one experience that the user has obtained, or both. The one or more computer processors may further be configured to recommend the job to the user.

In accordance with other aspects of this embodiment, the one or more processors may further be configured to determine that the job matches at least one of a preference of the user, a personality of the user, an interest of the user, a purpose of the user, or any combination thereof

In still another embodiment, techniques disclosed herein may be realized as a method for facilitating career, skill, and experience management such that a career recommendation can be automatically recommended to a user. According to the method, data indicative of at least one skill that a user has obtained and at least one experience that the user has obtained may be stored in a database. A statement of the user may be received. The statement may comprise an objective that the user wants to achieve. That the statement comprises a goal of the user to improve a skill, an experience, or both may be determined using a semantic analysis. The semantic analysis may comprise decomposing the statement into one or more search terms. The at least one skill that the user has obtained, the at least one experience that the user has obtained, or both may be queried. A recommendation in response to the user's goal may be determined. The recommendation may be determined based on the at least one skill that the user has obtained, the at least one experience that the user has obtained, or both. The recommendation to the user may be provided.

The present disclosure will now be described in more detail with reference to particular embodiments thereof as shown in the accompanying drawings. While the present disclosure is described below with reference to particular embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

### BRIEF DESCRIPTION OF FIGURES

Various objectives, features, and advantages of the disclosed subject matter can be more fully appreciated with reference to the following detailed description of the disclosed subject matter when considered in connection with the following drawings, in which like reference numerals identify like elements.

FIG. 1 shows an exemplary system diagram showing the networked system for providing dynamic career management, according to some embodiments;

FIG. 2 shows an exemplary a career options recommendation engine that provides users a list of other career possibilities based upon multiple variables and data, according to some embodiments;

FIG. 3 shows exemplary user data, according to some embodiments;

FIG. 4 shows an exemplary computerized process for extracting job market data from the web;

FIG. 5 shows an exemplary computerized process for compiling and creating a success profile for each job group, according to some embodiments;

FIG. 6 shows an exemplary computerized process for recommending/finding career options for users, according to some embodiments;

FIG. 7 shows an exemplary computerized process for generating the list of career options that is recommended to users, according to some embodiments;

FIG. 8 shows exemplary user actions, according to some embodiments;

FIG. 9 shows an exemplary computerized process of taking a job description corpus, tagging specific data, and then mapping them to specific fields, according to some embodiments;

FIG. 10 shows an exemplary computerized process of taking all jobs data and building a profile that reflects the successful attributes for each job group, according to some embodiments;

FIG. 11 shows an exemplary computerized process of the gap analysis, according to some embodiments;

FIG. 12 shows an exemplary computerized process of the recommendations made when a gap is found, according to some embodiments;

FIG. 13 shows an exemplary computerized process curating resources for users, according to some embodiments;

FIG. 14 shows an exemplary computerized process of taking a number combination of skills from users skill list to find job groups that have the same skills, according to some embodiments;

FIG. 15 shows an exemplary detailed view of possible company data, according to some embodiments;

FIG. 16 shows an exemplary people recommendation engine that provides users a list of other users to connect with based upon multiple variables and data, according to some embodiments.

FIG. 17 shows an exemplary detailed view of the user interface(s), according to some embodiments.

FIG. 18 shows an exemplary process of how experiences can be posted to an experience marketplace for other users to complete and gain, according to some embodiments.

FIG. 19 shows a detailed view of the interactive brain, according to some embodiments.

FIG. 20 shows an exemplary computerized process of the conversation system, according to some embodiments;

FIG. 21 shows an exemplary computerized process of the proactive system, according to some embodiments;

FIG. 22 shows an exemplary flow chart for the career options recommendation, according to some embodiments.

FIG. 23 shows an exemplary flow chart for the resources recommendation, according to some embodiments.

FIG. 24 shows an exemplary flow chart for the experiences recommendation, according to some embodiments.

### DETAILED DESCRIPTION

If users were given the option to specify a career destination and/or create a specific or generalized career goal (or purpose) statement and have a system that not only guides their career, but provides a means to develop it, they would improve their chances of success. Our career management system doesn't require users to submit or define a career destination nor a career goal (or purpose) statement parameter, instead we first provide users with recommendations on possible career goals/destinations and statements/purposes to open their eyes to the potential and opportunity they truly have. In addition, the system also provides users with recommendations on various resources and provide a means to gain additional experiences that might assist them in their career, with emphasis on both day-to-day and long term. This is especially important today when jobs/careers, markets, and technologies are changing so rapidly that it's hard for people to keep up, recognize, and position themselves for all the opportunity.

The techniques described herein provide for a career management platform accessed by users (e.g., employees) through many mediums to help them manage and navigate their careers. The platform allows users to discover other potential opportunities that they may be interested in, provide relevant resources, and provide a means to gain experiences to help close various skills gaps and/or develop vital skills related to their current career, selected career destination, and/or defined career goals (purpose) statement. For example, rather than a user setting a particular end-goal or career, the system provides greater flexibility by dynamically evaluating data points from the user and other relevant data points using the techniques described herein to provide recommendations on different career paths (e.g., and/or additional skills required for each of the recommended career paths). In addition, users may enter a generalized or specific career goal (or purpose) statement and the system will provide the user with various resource recommendations and experiences they might be interested in gaining.

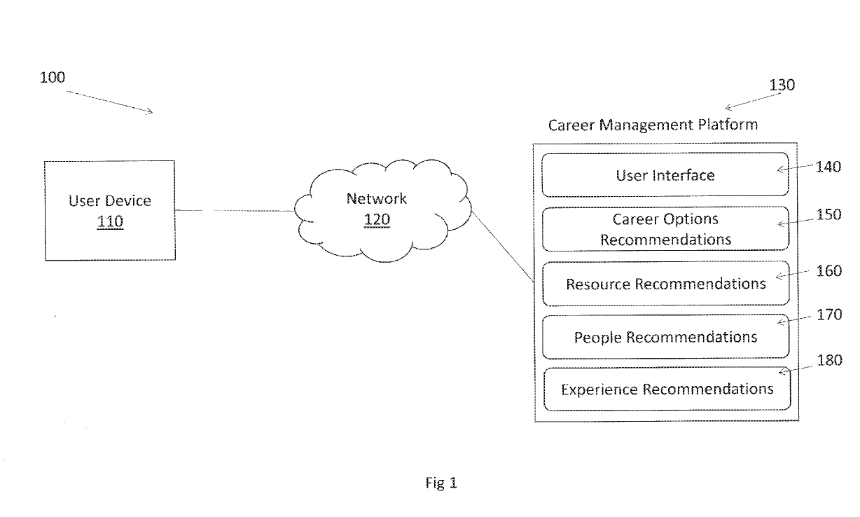

FIG. 1 shows an exemplary system diagram showing the networked system 100 for providing dynamic career management, according to some embodiments. System 100 includes a user device 110, a network 120, and a career management platform 130, also referred to generally herein as the Platform. Career management platform 130 includes a user interface 140, a career options recommendation engine 150, a resource recommendations engine 160, and a people recommendations engine 170.

User device 110 is in communication with network 120. The user device 110 can be any device capable of communicating with network 120. For example, the user device 110 can be a desktop computer, a laptop or other mobile computer, a personal computer, a tablet computer, cell phone or other cellular device (e.g., including a personal digital assistant (PDA)), a smartphone, or any computing system that is capable of performing computation and runs one or more client software programs.

Network 120 is the access point for user device 110 and also hosts the career management platform 130. The network 120 can be any server (or multiple servers) hosted by any party at any location including 3^{rd} party cloud provider. The network 120 can include a network or combination of networks that can accommodate private data communication. For example, network 120 can include a local area network (LAN), a virtual private network (VPN) coupled to the LAN, a private cellular network, a private telephone network, a private computer network, a private packet switching network, a private line switching network, a private wide area network (WAN), a corporate network, or any number of private networks that can be referred to as an Intranet. Such networks may be implemented with any number of hardware and software components, transmission media and network protocols. FIG. 1 shows network 120 as a single network; however, communication network 120 can include multiple interconnected networks listed above.

The Platform 130 is the career management platform/application that users (e.g., via user device 110) engage with. The career management platform 130 includes a user interface 140, a career options recommendation engine 150, and a resource recommendations engine 160. The Platform 130 can be provided by one or more web servers. The one or more web servers can include one or more databases, not shown. For example, the database can include at least one of two types of database: a local database and a remotely located database. The database can include any data supported by one or more of data structures; alternatively, it could include one or more database management system (DBMS) or a distributed database. For example, the database may include a data structure, or one or more data tables in a DBMS, for storing information related to one or more secure file storage areas and files contained in the secure file storage areas. The database can also include at least one of a relational database, non-relational database, object database (a.k.a., object-oriented database), XML database, cloud database, active database, and a data warehouse. The database may include at least one physical, non-transitory storage medium.

The one or more web servers can include one or more processors. The processors can be configured to implement the functionality described herein using computer executable instructions stored in a temporary and/or permanent non-transitory memory. The memory can be flash memory, a magnetic disk drive, an optical drive, a programmable read-only memory (PROM), a read-only memory (ROM), or any other memory or combination of memories. The processor can be a general purpose processor and/or can also be implemented using an application specific integrated circuit (ASIC), programmable logic array (PLA), field programmable gate array (FPGA), and/or any other integrated circuit. Similarly, the database may also be flash memory, a magnetic disk drive, an optical drive, a programmable read-only memory (PROM), a read-only memory (ROM), or any other memory or combination of memories. The server can execute an operating system that can be any operating system, including a typical operating system such as Windows, Windows XP, Windows 7, Windows 8, Windows 10, Windows Mobile, Windows Phone, Windows RT, Mac OS X, Linux, VXWorks, Android, Blackberry OS, iOS, Symbian, or other OSs. While not shown, the server can include a processor and/or memory.

User interface 140 is the graphical user interface for the career management platform 130 that users interact with.

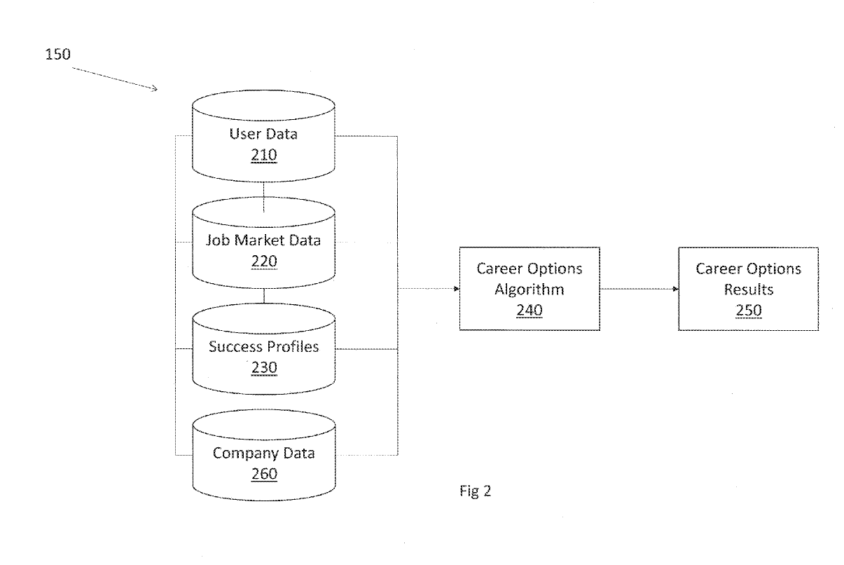

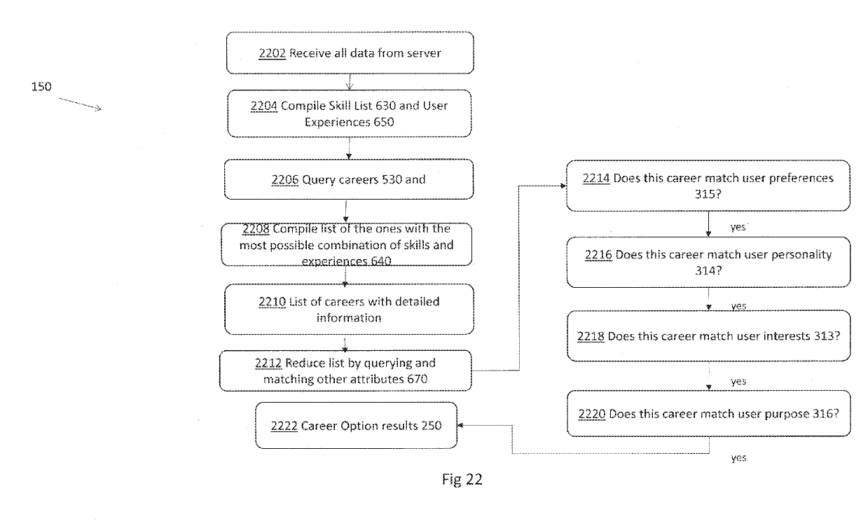

Career options recommendation engine 150 recommends users other possible career options based upon multiple variables and data, as described further in conjunction with FIGS. 2 and 22.

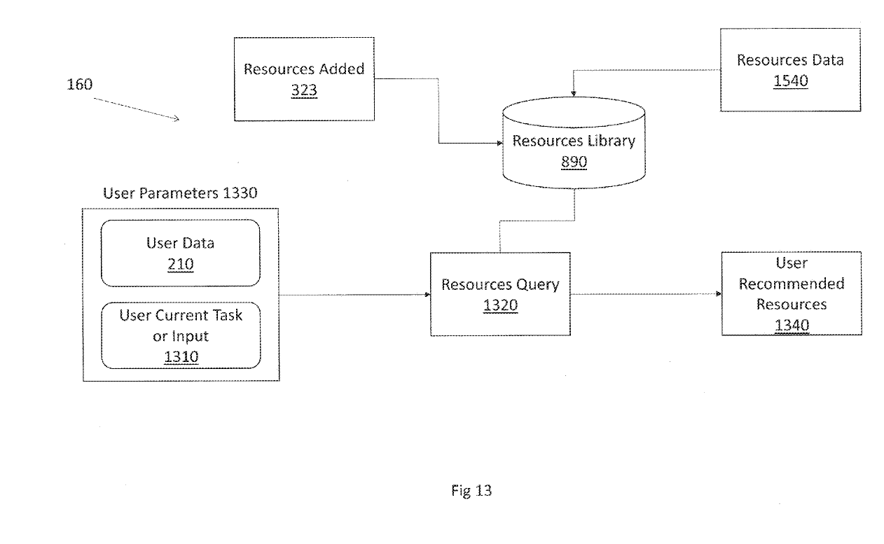

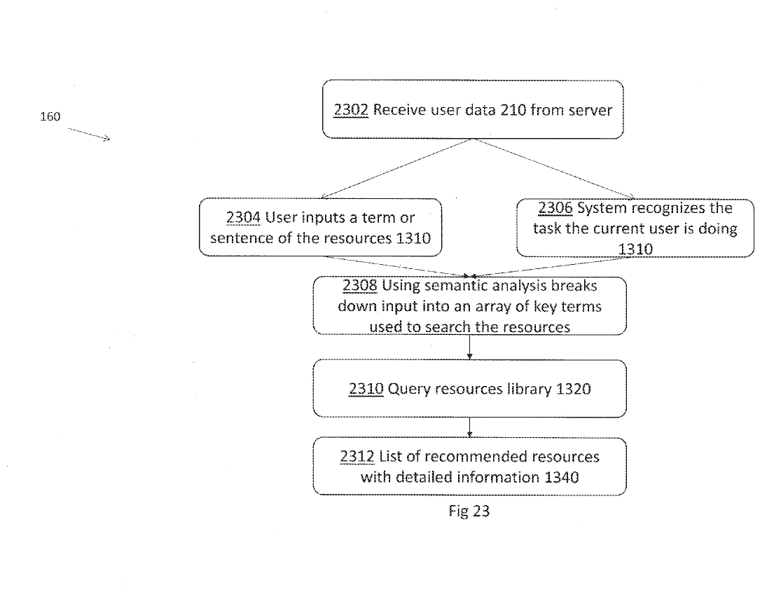

Resource recommendation engine 160 recommends users resources (articles, podcasts, videos, courses, etc. . . . ) based upon multiple variables, as described further in conjunction with FIGS. 13 and 23.

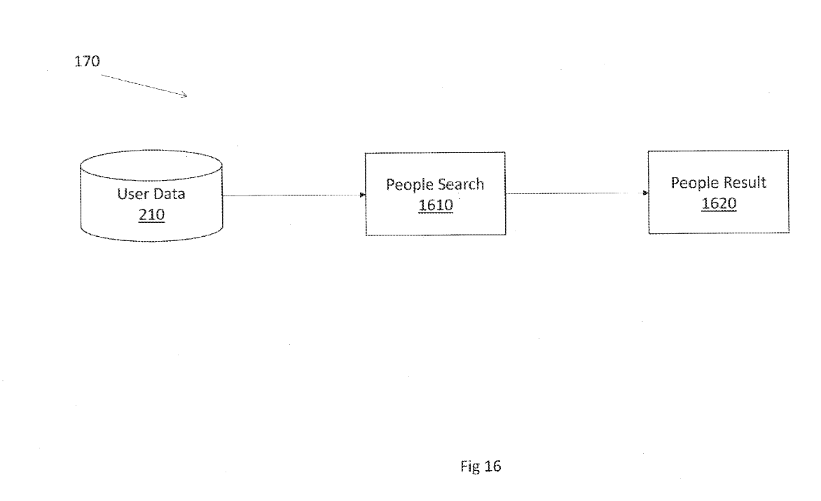

People recommendation engine 170 provides users a list of other users to connect with based upon multiple variables and data, as described further in conjunction with FIG. 16.

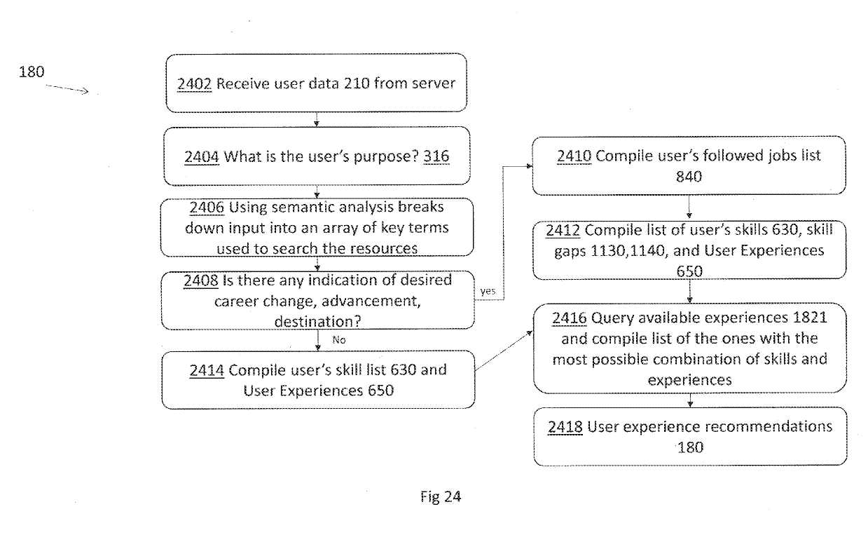

Experience recommendation engine 180 provides users a list of experiences that they might be interested in based upon multiple variables and data, as described further in conjunction with FIG. 24.

FIG. 2 shows an exemplary a career options recommendation engine 150 that provides users a list of other career possibilities based upon multiple variables and data, according to some embodiments. Career options recommendation engine 150 includes User data 210, job market data 220, success profiles 230, company data 260, career options algorithm 240, and career options results 250.

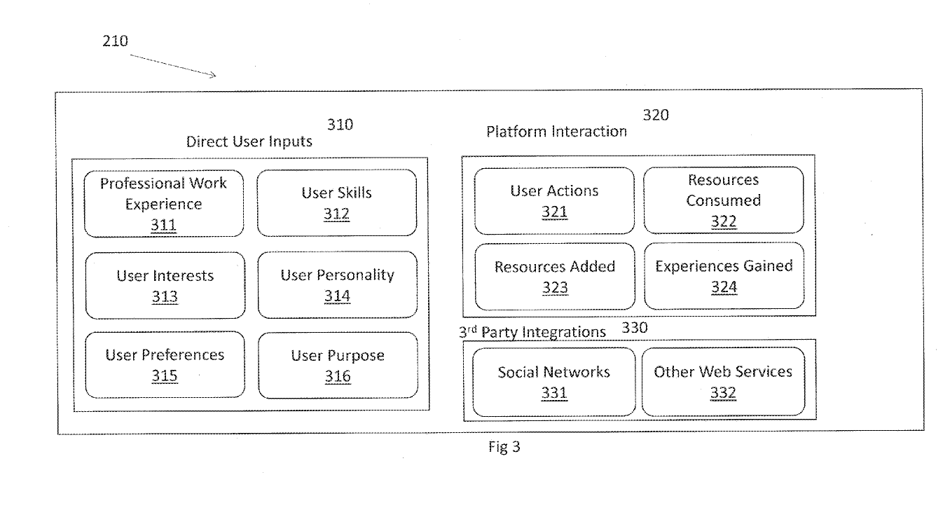

User data 210 includes all possible user data entered, collected, or received by any other means through the users, as described further in conjunction with FIG. 3. User data 210 includes direct user inputs 310 and platform interaction 320.

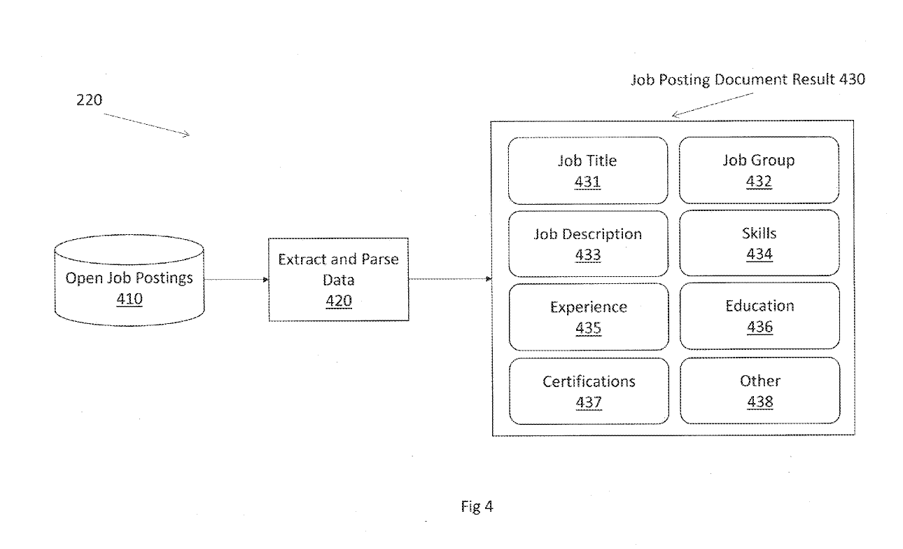

Job market data 220 includes all possible jobs data entered, collected, or received by any other means through external company job postings and the like, as described further in conjunction with FIG. 4.

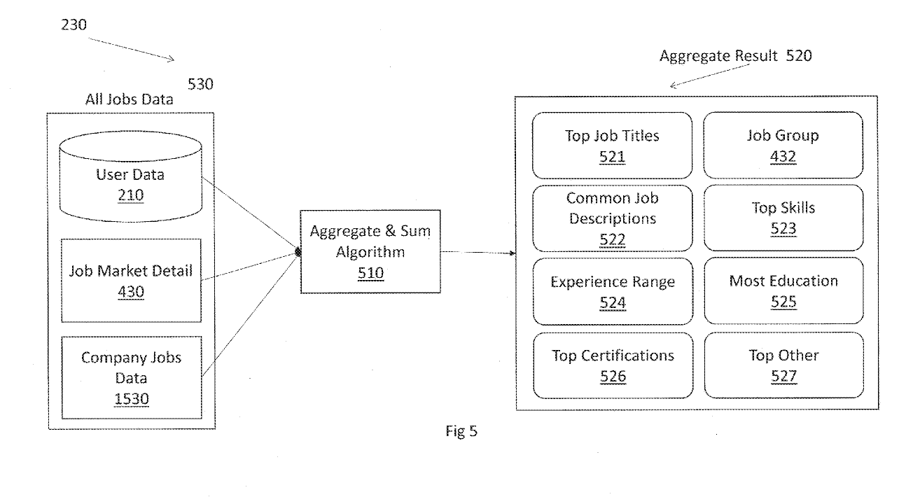

Success profiles 230 are the current ideal/optimal job position make-ups dependent upon: 1. user data 210 and 2. aggregate job market data 430, as described further in conjunction with FIG. 5.

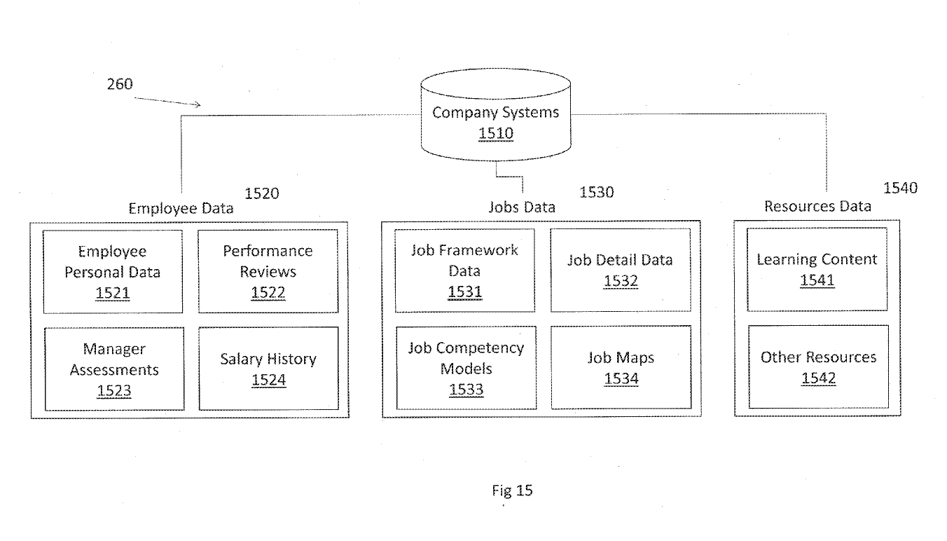

Company data 260 includes all possible data entered, collected, or received by any other means through companies, as described further in conjunction with FIG. 15.

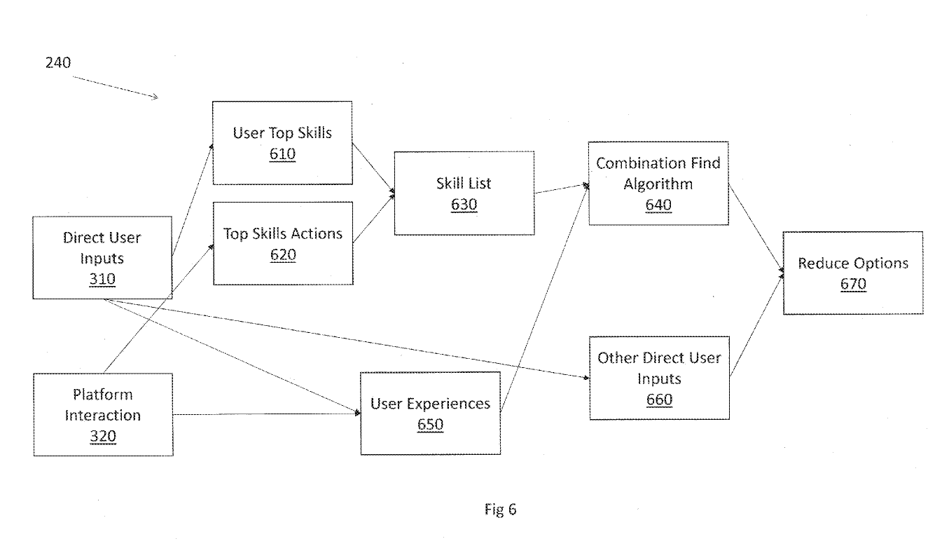

Career options algorithm 240 is a computational formula designed to use all possible data: User data 210, job market data 220, success profiles 230, company data 260 to find other possible careers for users, as described further in conjunction with FIG. 6.

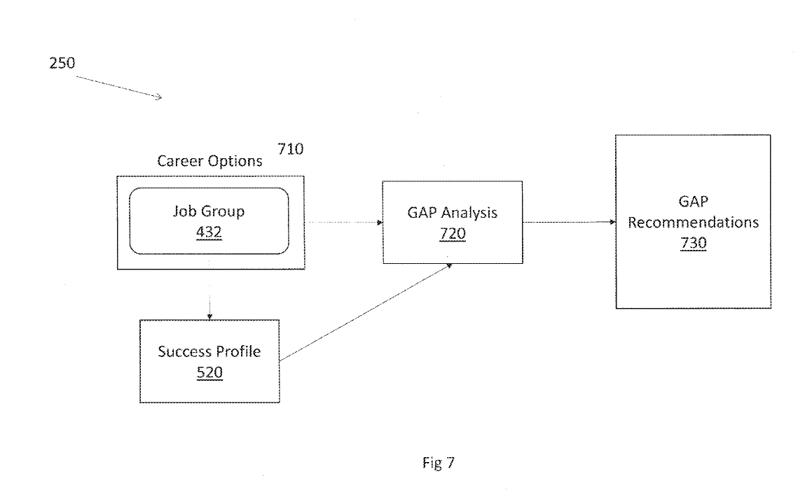

Career options results 250 is the resulting list of other possible careers for users determined by the career options algorithm 240, as described further in conjunction with FIG. 7.

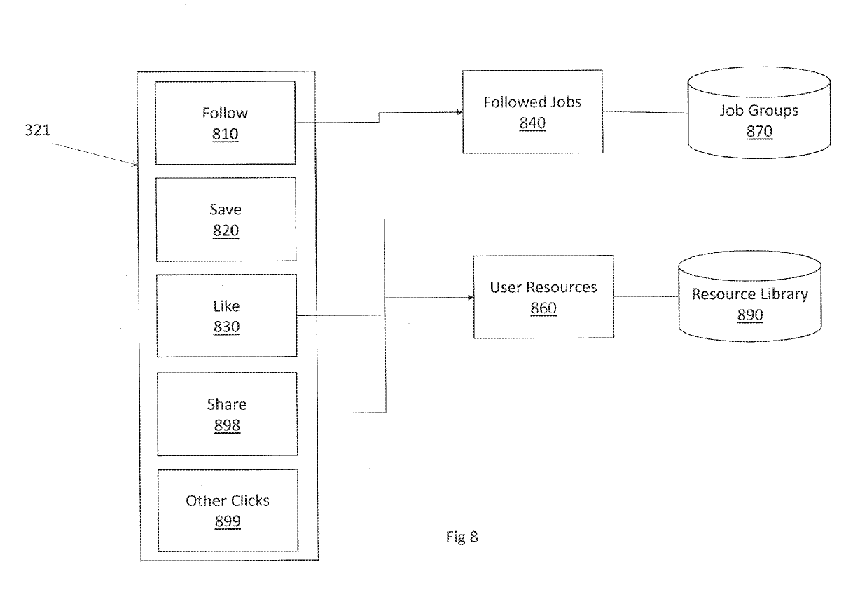

FIG. 3 shows an exemplary detailed look into possible user data 210, it includes direct user inputs 310, platform interaction 320, and 3^{rd} party integrations 330. Direct user inputs 310 includes professional work experience 311, user skills 312, user interests 313, user personality 314, user preferences 315, and user purpose 316. Platform interaction 320 includes user actions 321 (which will be described in further detail in FIG. 8), resources consumed 322, resources added 323, and experiences gained 324. 3^{rd} party integrations 330 includes social networks 331 and other web services 332.

Direct user inputs 310 is the data entered directly and voluntarily by the users through any medium. Direct user inputs 310 includes professional work experience 311, user skills 312, user interests 313, user personality 314, user preferences 315, and user purpose 316.

Professional work experience 311 is the detail on users professional work experience often found on a resume and may include, but is not limited to job titles, job history, salary information, company information, location information, job description, job accomplishments, experiences 324, performance ratings and the likes.

User skills 312 are skills entered and rated by the users. These are often directly related to and found in their professional work experience 311. For example, a skill can be SQL, Leadership, Accounting, Finance, Nanotechnology.

User interests 313 are professional, recreational, and other interests entered by the users. For example, an interest can be hockey, computers, shopping, snowboarding, golf, restaurants.

User personality 314 is personality data entered by the user or collected by a personality assessment. For example, the personality data can include introvert, extrovert.

User preferences 315 is preference data entered by the user, this usually includes, but is not limited to desired salary, desired location, desired travel frequency, and the likes.

User purpose 316 is a statement or series of multiple statements entered by the user that describes their career purpose and/or goals they are striving for. User purpose 316 may be entered by the user or built by the user using recommendations from the system, e.g., using the career recommendation engine, experience recommendation engine, etc. These could be short-term or long-term and focus on anything related to their career. For example, “I'd like to improve my collaboration skills among my colleagues.” Or, “I'd like to learn SQL for my next job.” In addition, the user can leave this blank or build a statement or series of multiple statements by receiving recommendations from the career options recommendations 150, GAP recommendations 730, experience recommendations 180, etc.

Platform interaction 320 is the data collected as users interact with the user interface 140 through any user device 110. Platform interaction 320 includes user actions 321 (which will be described in further detail in FIG. 8), resources consumed 322, resources added 323, and experiences gained 324.

User actions 321 (which will be described in further detail in FIG. 8) is all data collected from users as they complete an action on the user interface 140. User actions 321 includes follow 810, save 820, like 830, share 898, other clicks 899.

Resources consumed 322 is all resources that has been read, listened to, watched, or any type of interaction completed by the user. Resources can include a corpus of information (news articles, blog posts, etc.), video, podcast, and/or other resources the user can view and/or access.

Resources added 323 is all resources that has been added voluntarily by the user. Resources can include a corpus of information (news articles, blog posts, etc.), video, podcast, and/or other resources curated, sourced, or created by the user.

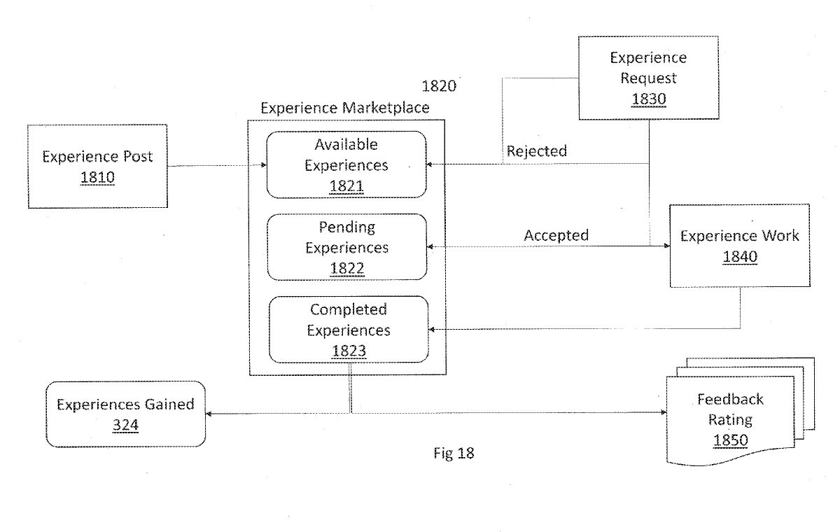

Experiences gained 324 (which will be described in further detail in FIG. 18) is a list of all experiences with feedback and ratings the user has obtained through the platform.

3^{rd} party integrations 330 is the data collected from 3^{rd} party sources by connecting via application programming interface (API). 3^{rd} party integrations 330 includes social networks 331 and other web services 332.

Social networks 331 is user data collected from any possible social network website integration. For example, user data from Facebook.com.

Web services 332 is any user data collected from any possible website other than social network websites through integration. For example, user data from education and course sites like Coursera, Udemy, and the likes, or from collaboration sites like Dropbox and Google Drive.

FIG. 4 shows an exemplary process for extracting job market data 220 from the web. The process uses public gateways to collect job posting and extract information from each. It then tags the information that has been extracted. For example, job title is found and tagged as “Job Title”. It includes, open job postings 410, extract and parse data 420, and job posting document result 430. Job posting document result 430 includes job title 431, job group 432, job description 433, skills 434, experience 435, education 436, certifications 437, and other 438.

Open job postings 410 is a collection of job postings collected from the web through public gateways within a certain time period. For example, job postings can include job postings from a company website, a social network, search page.

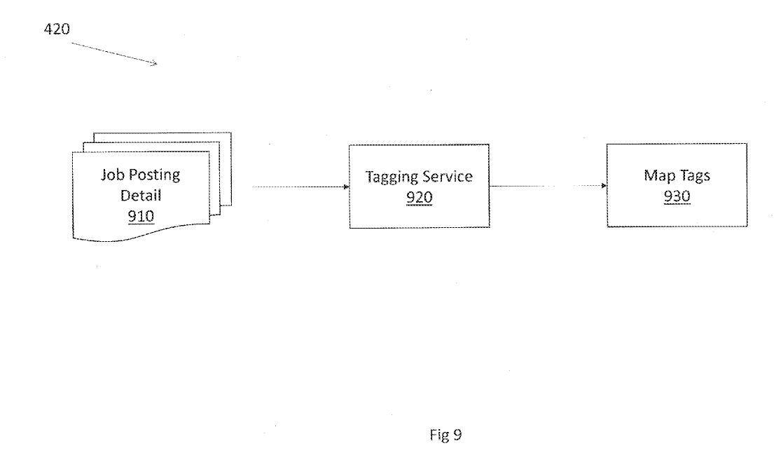

Extract and parse data 420 is the process of extracting various information from each job posting in Open job postings 410 and creates a new document with the job posting document result 430, as described further in conjunction with FIG. 9.

Job posting document result 430 is the resulting document from extract and parse data 420, it includes job title 431, job group 432, job description 433, skills 434, experience 435, education 436, certifications 437, and other 438.

Job title 431 is the title of each job posting in open job postings 410. For example, SQL Database Administrator II, Junior Data Analyst, and Sales Manager I.

Job group 432 is the group each job posting in open job postings 410 belongs to. It is different than the Job title 431, in that there could be many job titles in a job group 432. For example, job titles SQL Database Administrator, Database Administrator II, and Oracle Database Administrator belong to the job group Database Administrator. In some examples, this belongs to the ultimate data structure referred to as job hierarchy. The job hierarchy is part of the database job groups 870, it is a detailed taxonomy of how jobs/career data is structured/managed. The structure is job functions to job groups to job titles, e.g. a job function has many job groups and a job group has many job titles. Job function is a functional area, for example technology, accounting, sales. Therefore, as an example, technology is the job function, within technology there are multiple job groups, database administrator and data analyst, and within the job groups are multiple job titles, SQL Database Administrator, Database Administrator II, Data Analyst I, Sr. Data Analyst, and/or the like.

Job description 433 is the description of each job posting in open job postings 410. For example, Database Administrator is responsible for managing all company databases.

Skills 434 is a list of the skills found in each job posting in open job postings 410. For example, SQL, database, leadership.

Experience 435 is the length of time specified for work experience of each job posting in open job postings 410. For example, mid-level, senior level, manager level or 3-5 years, 2-4 years.

Education 436 is the education level requirement of each job posting in open job postings 410. For example, bachelors degree, masters degree, and/or the like.

Certifications 437 is a list of certifications recommended and/or required of each job posting in open job postings 410. For example, Certified Public Accountant, Registered Nurse.

Other 438 is any other requirements found that are not mapped to any other field for each job posting in open job postings 410. For example, data structure should be mapped to Skills 434, but does not get tagged at all so the system can map to Other 438 to insure everything found is tagged and saved for future use and analysis.

FIG. 5 shows an exemplary process for compiling and creating a success profile 230 for each job group. The system first aggregates all jobs data 530, which includes user data 210, job market detail 430, and company jobs data 1530. Next the system finds correlations/patterns to ultimately build out a list of top attributes for each job group, referred to as aggregate result 520; this is dynamic and always changes to keep data real-time and up-to-date. It includes all jobs data 530, aggregate and sum algorithm 510, and aggregate result 520.

All jobs data 530 shows an exemplary detailed look into possible jobs data 530, it includes user data 210, job market detail 430, and company jobs data 1530.

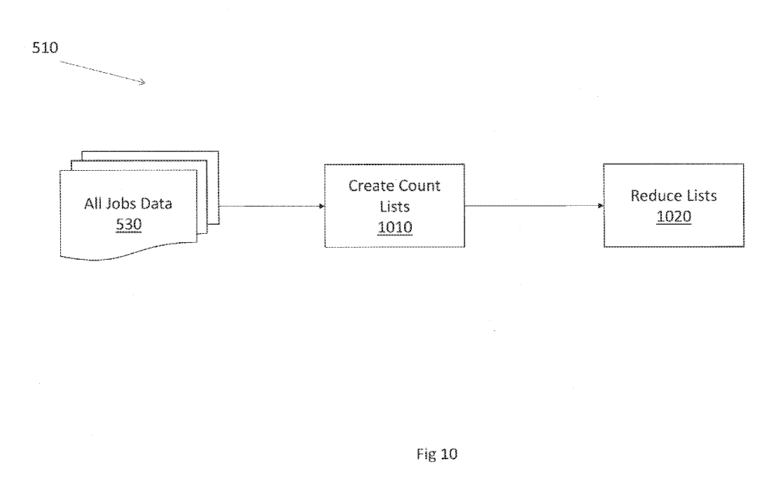

Aggregate and sum algorithm 510 is a process to take all jobs data 530 and build a profile that is most common for each job group 432, the result is aggregate result 520, as described further in conjunction with FIG. 10.

Aggregate result 520 is the resulting document created from the aggregate and sum algorithm 510. As an example, the process basically takes 10 Data Analysts positions and reduces to 1 aggregated result.

Top job titles 521 is a list of job titles 431 sorted descending by count for each job group 432 in open job postings 410, produced from the aggregate and sum algorithm 510. For example, the database administrator job group 432 might have SQL Database Administrator and Oracle Database Administrator as its top job titles 521 because they each had the highest number of job postings in open job postings 410.

Common job descriptions 522 is a list of job descriptions 433 sorted descending by count for each job group 432 in open job postings 410, produced from the aggregate and sum algorithm 510.

Top skills 523 is a list of skills 434 sorted descending by count for each job group 432 in open job postings 410, produced from the aggregate and sum algorithm 510.

Experience range 524 is a list of experience 435 sorted descending by count for each job group 432 in open job postings 410, produced from the aggregate and sum algorithm 510.

Most education 525 is a list of education 436 sorted descending by count for each job group 432 in open job postings 410, produced from the aggregate and sum algorithm 510.

Top certifications 526 is a list of certifications 437 sorted descending by count for each job group 432 in open job postings 410, produced from the aggregate and sum algorithm 510.

Top other 527 is a list of other 438 sorted descending by count for each job group 432 in open job postings 410, produced from the aggregate and sum algorithm 510.

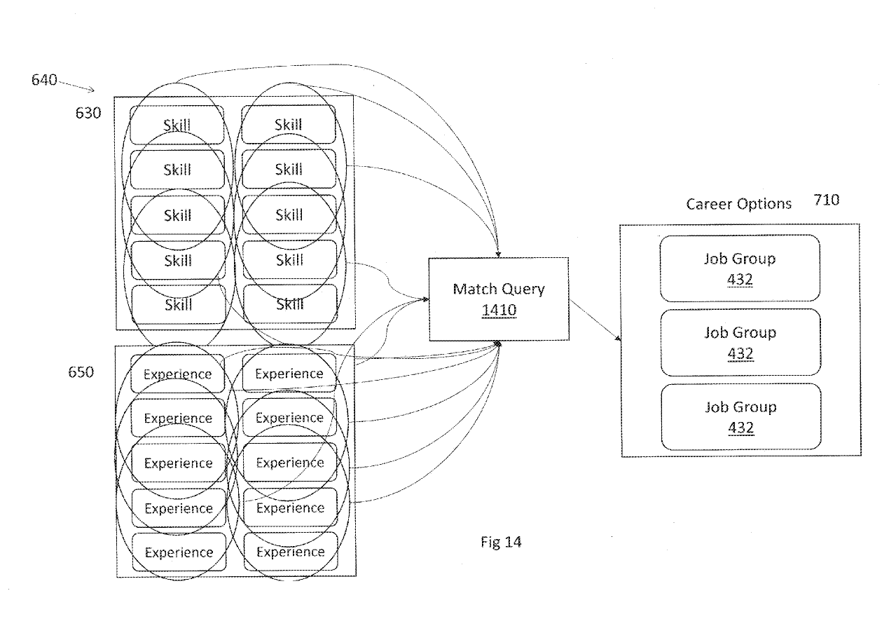

FIG. 6 shows an exemplary process for recommending/finding career options for users, this is referred to as career options algorithm 240. The process takes various data about the user and compiles a list of top skills, referred to as Skill list 630, a list of user experiences 650, and a list other direct user inputs 660. Skill list 630 and user experiences 650 is used as parameters in the combination find algorithm 640, as described further in conjunction with FIG. 14. It includes direct user inputs 310, platform interaction 320, top skills 610, top skills actions 620, skill list 630, combination find algorithm 640, user experiences 650, other direct user inputs 660, and reduce options 670.

User top skills 610 is a list of top skills for each user based on user inputted rating and/or assessment (in future). For example, user could have SQL, database rated as their top skills and therefore would appear at the top of their list.

Top skills actions 620 is a list of skills for each user based on user actions on the platform. For example, user spends most of their time on the platform consuming SQL and law resources/information.

Skill list 630 is compiled list of skills by aggregating user top skills 610 and top skills actions 620.

Combination find algorithm 640 takes a combination of the skills from Skills List 630 and finds jobs that have those skills, as described further in conjunction with FIG. 14.

User experiences 650 are all the experiences that the user has completed, it includes experiences gained 324 and work experience 311.

Other direct user inputs 660 are all other user inputs from direct user inputs 310 that have not been previously mentioned.

Reduce options 670 is a reduced list of career options by using the other direct user inputs 660, see more detail in FIG. 22.

FIG. 7 shows an exemplary process of generating the list of career options that is recommended to users, referred to as career options results 250. User can click on each career/job to learn more about the success profile 520 and understand user shortfalls or gaps. Recommendations on how to close and fill gaps are also provided. It includes career options 710, success profile 520, gap analysis 720, and gap recommendations 730.

Career options 710 is a detailed list of other possible careers for each user with drill down information. It includes success profile 520, gap analysis 720, and gap recommendation 730. For example, Data Analyst, Database Administrator.

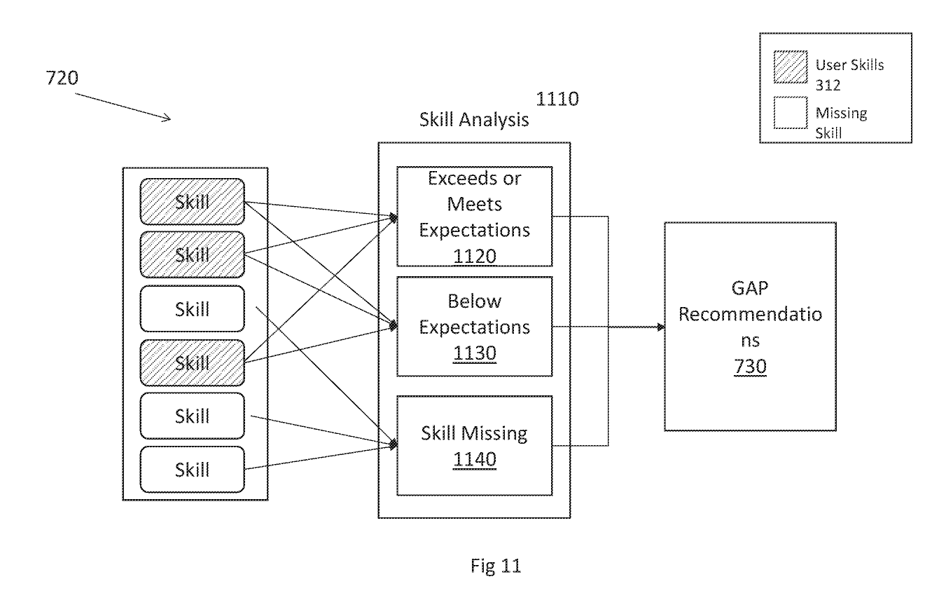

GAP analysis 720 compares the user to the success profile 520 of each recommended job group 432, it can show what gaps exist. For example, if the user is missing SQL, or has beginning Java, but Advanced Java is required, as described further in conjunction with FIG. 11.

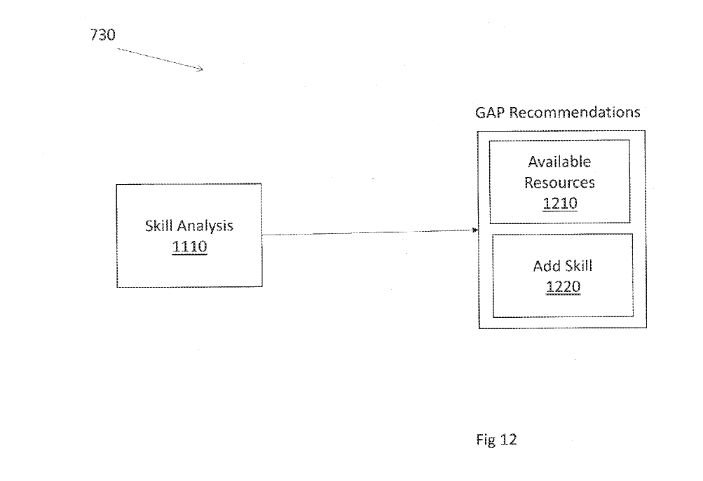

GAP recommendations 730 provides the user with actions to help fill the gaps shown in GAP analysis 720. For example, learn SQL or improve Java, as described further in conjunction with FIG. 12.

FIG. 8 shows an exemplary detailed look into possible user actions 321. It includes follow 810, save 820, like 830, followed jobs 840, user resources 860, job groups 870, resource library 890, Share 898, and other clicks 899.

Follow 810 is a user action 321 where a user can follow job groups 432 in order to start receiving information on it. For example, if a user follows Data Analyst they can begin to receive open jobs on Data Analyst.

Save 820 is a user action 321 where a user can save resources to read/consume at a later point in time. For example, if a user saves an article on SQL they can access and read/consume it at a future time.

Like 830 is a user action 321 where a user can like resources to stress interest in the content, topic, skill, etc.

Followed jobs 840 is a list of job groups 432 each user is following.

User resources 860 is a list of resources that has been saved or liked by the user.

Job groups 870 is a database for all job groups 432 that are updated according to the real-time job market or supplied by the company.

Resource Library 890 is a database for all resources curated from the web, company, and employees

Share 898 is a user action 321 where a user can share resources with other users.

Other Clicks 899 is a user action 321 that includes any other click on the platform, other than follow 810, save 820, like 830, and share 898, for example discover, read, submit.

FIG. 9 shows the detailed exemplary process of taking a job description corpus, tagging specific data, and then mapping them to specific fields, referred to as extract and parse data 420 (see, e.g., FIG. 4). It includes job posting detail 910, tagging service 920 and map tags 930.

Job posting detail 910 grabs corpus of each job posting in open job postings 410.

Tagging service 920 is a service that tags content in job posting detail 910 according to its respective information. For example, job title Database Administrator is tagged as job title.

Map tags 930 is the process of connecting tags to corresponding job posting result document fields 430. For example, job title tag is mapped to job title 431.

FIG. 10 shows the detailed exemplary process of taking all jobs data 530 and building a profile that reflects the successful attributes for each job group 432, referred to as aggregate and sum algorithm 510 (see, e.g., FIG. 5). It includes all jobs data 530, create count lists 1010, and reduce lists 1020.

Create count lists 1010 is the process of counting all possible results for each job category (e.g. skills, education, certification, etc.) in aggregate result 520 and sorting the list descending by count.

Reduce lists 1020 is a process that cuts down the lists created in create count lists 1010 to a smaller list of items that consists of the highest counts.

FIG. 11 shows the detailed exemplary process of the Gap analysis 720 which takes users skills 312 and compares it to the skills of each recommended job group 432 in career options 710. Then it makes recommendations on what to do dependent upon certain conclusions drawn from the process. It includes skill analysis 1110 and gap recommendations 730.

Skill analysis 1110 is a process that analyzes whether user skills 312 exceed, meet, are below, or are missing in regards to being compared with each skill in each recommended job group 432 in career options 710. It includes exceeds or meets expectations 1120, below expectations 1130, and skill missing 1140.

Exceeds or meets expectations 1120 is if user has skill and exceeds or meets expectations. For example, if intermediate java then user has intermediate level or higher java.

Below expectations 1130 is if user has skill and is below expectations. For example, if intermediate java then user has beginner java or comparable.

Skill Missing 1140 is if user is missing skill altogether. For example, intermediate java is required and user does not have java at all.

FIG. 12 shows the detailed exemplary process of the recommendations made when a gap is found, referred to as GAP recommendations 730, see FIG. 7. It includes skill analysis 1110, available resources 1210, and add skill 1220.

Available resources 1210 is a link to all the resources available for the skill.

Add skill 1220 is a recommended action for the user to take; they should add the skill to their profile to make it more complete, and improve recommendations, etc.

FIG. 13 shows the detailed exemplary process curating resources for users, it is referred to as the resource recommendations engine 160, see FIG. 1. It includes resources added 323, resources library 890, resources data 1540, user parameters 1330, user data 210, user current task or input 1310, resources query 1320, and user recommended resources 1340.

User current task or input 1310 is the specific detail on what a user is currently doing on his computer or the specific detail the user inputs. For example, if a user is working on a PowerPoint related to sales, the system will recognize this and use this information as part of the user parameters 1330. Or the user can directly type PowerPoint sales' and it will be used as part of the user parameters 1330.

Resources query 1320 is the process of creating resources recommendation for each user by grabbing all resources based on user parameters 1330.

User parameters 1330 is all data related to the user, it includes user data 210 and user current task or input 1310.

User recommended resources 1340 is the final collection of resources for each user. This is highly dynamic and changes according to the User parameters 1330 and available resources library 890 as determined by the resources query 1320.

FIG. 14 shows the detailed exemplary process of taking a number combination of skills from users skill list 630 to find job groups 432 that have the same skills, referred to as combination find algorithm 640, see FIG. 6. It includes skills list 630, user experiences 650, match query 1410, and career options 710. For example, the combination formula C(n, r)=(n!/r!(n−r)!) can be used to determine possible number of combinations, n is the number of user skills or experiences and r is the number of skills in each group; if n=10 and r=3 then C (i.e. number of combinations)=120.

Match query 1410 is the process that takes combination of x skills and y experiences and finds job groups 432 that have x skills and y experiences. For example, if user has SQL, data, and leadership as skills and “mapping data with SQL” as experiences then the match query 1410 can find jobs with SQL, data, and leadership as skills and “mapping data with SQL” as experiences. As a further example, x=4 means that the Match query 1410 will take any 4 skills and/or experiences from the user skill list 630 and uses them to find jobs with the same 4 skills.

FIG. 15 is a detailed view of possible company data 260, e.g. data received by a company commonly housed in company systems 1510. It includes company systems 1510, employee data 1520, jobs data 1530, resources data 1540, employee personal data 1521, performance reviews 1522, manager assessments 1523, salary history 1524, jobs data 1530, job framework data 1531, job detail data 1532, job competency models 1533, job maps 1534, learning content 1541, and other resources 1542.

Company systems 1510 is a company's system used to manage its people/employees and jobs. It includes employee data 1520, jobs data 1530, and resources data 1540. In some examples, the Company systems 1510 could be multiple systems, for example, human resource system, accounting system, payroll system.

Employee data 1520 is any data that the company systems 1510 has on employees. It includes employee personal data 1521, performance reviews 1522, manager assessments 1523, and salary history 1524.

Employee personal data 1521 is basic personal information on employees. For example, address, age, position.

Performance reviews 1522 is any performance metrics on employees. For example, user improved communication skills last quarter.

Manager assessments 1523 is any performance assessments on managers. For example, manager truly understands how to manage people and improved last quarter.

Salary history 1524 is any data related to user salary. For example, user makes $65,000 annually, up from $55,000 last year.

Jobs data 1530 is any data that the company systems 1510 has on possible jobs/career company data. It includes job framework data 1531, job detail data 1532, job competency models 1533, and job maps 1534.

Job framework data 1531 is job hierarchy data for the company. This specifies the structure and often sets the organization chart of the company. Job hierarchy often starts with functional area, then within the functional area there are job groups, and within job groups there are job titles. For example: technology is the job function, database administrator is the job group, and the job titles within the job group (database administrator) are: senior database administrator, junior database administrator, and database administrator manager.

Job detail data 1532 is detail on job descriptions and requirements for positions within the company.

Job competency models 1533 is more detail on jobs that specify competencies and levels required for positions within the company.

Job maps 1534 is any data on career paths or possible vertical/horizontal movements between positions within the company.

Resources data 1540 is any data that the company systems 1510 has that could be used to help in day-to-day work, learning or advancing a skillset, news, etc. It includes learning content 1541 and other resources 1542.

Learning content 1541 is any data/content that is used to learn or advance a skillset, examples are LMS, articles, etc.

Other resources 1542 is any additional data/content that could be used to assist in day-to-day job or learning/advancing knowledge.

FIG. 16 shows an exemplary people recommendation engine 170 that provides users a list of people to connect with based upon multiple variables and data, according to some embodiments. People recommendation engine 170 includes User data 210, people search 1610, and people result 1620.

People search 1610 is the process of taking combination of user data and finding other users who are considered experts in specific job groups 432, skills 431, and/or experience 435.

People result 1620 is the resulting list of people generated from people search 1610.

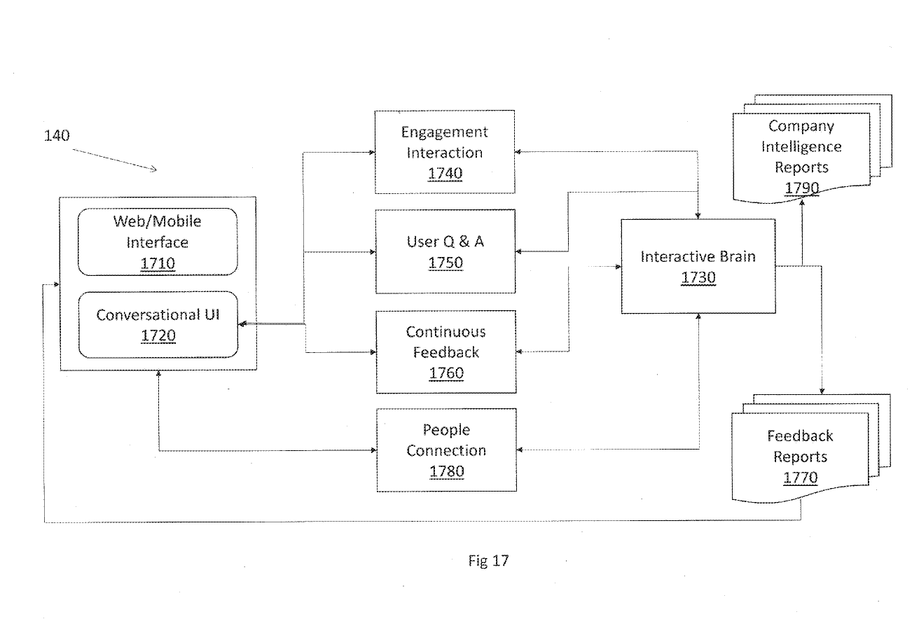

FIG. 17 shows an exemplary user interface 140 that provides users with an interface to interact with the career management platform 130, according to some embodiments. User interface 140 includes Web/mobile interface 1710, conversational ui 1720, interactive brain 1730, engagement interaction 1740, user q & a 1750, continuous feedback 1760, feedback reports 1770, and people connection 1780.

Web/mobile interface 1710 is the standard application interface that is accessible via computer, mobile, and other personal devices.

Conversational ui 1720 is a different interface that is accessible via SMS text message via mobile phone, tablet, or any other device with such functionality, commonly referred to as a “Conversational UI”.

Interactive brain 1730 is an artificial intelligence and information hub to the whole career management platform 130, it is a sophisticated system that indexes, queries, analyzes, and uses all resources and data available.

Engagement interaction 1740 is a process in which the Interactive brain 1730 can engage the user with questions to learn more about the user and/or obtain feedback from the user about their experience, recommendations, etc. For example, how was the last recommended career you looked it or the last recommended mentor, or last recommended article, etc.? The user then responds and the data is stored and used in enhancing/improving the user experience.

User questions 1750 is a process in which the user can engage the Interactive brain 1730 with questions about anything in the career management platform 130. For example, what open opportunities exist in Boston for someone with my background looking to get into marketing? The Interactive brain 1730 would then respond with a detailed answer, for example, there are 3 open opportunities in Boston for someone with your background looking to get into marketing.

Continuous feedback 1760 is a process in which the Interactive brain 1730 can interact with and track users feedback related to their own progress towards Followed jobs 840 and/or User purpose 316. For example, How do I think I did against my own goals vs. how do I feel the company helped me achieve them vs. how do I feel my manager helped me? The Interactive brain 1730 would ask consistently over a period of time (e.g., weekly, monthly, etc.) and build a Feedback report 1770 and make it available to the user and potentially other users.

Feedback reports 1770 are reports built by the Continuous feedback 1760 process that are based upon how a user is progressing towards their stated goals, which may or may not include: Followed jobs 840 and/or User purpose 316.

People connection 1780 is a process in which the Interactive brain 1730 intelligently connects 2 users based upon the matching of various attributes and actions on the career management platform 130. The process would ask each user whether they'd be interested in connecting for a stated purpose determined by the People connection 1780 process. For example, user 1 and user 2 are asked if they would like to connect because they both have similar interests (SQL and music), are both in Boston, and user 1 is looking for help with SQL while user 2 is open to helping with SQL.

Company intelligence reports 1790 are reports built by the Interactive brain 1730 that analyze all available data. They provide useful holistic information about the company and its employees. For example, how does the current company compare with its respective industry in metrics like retention, engagement, etc. . . .

FIG. 18 shows an exemplary experiences gained 324 that provides users with a means to gain experiences through the career management platform 130. This is essentially an internal talent marketplace where users can post experience (tasks) and other users can offer their services to complete them. Users essentially outsource tasks from their job to other users within the company. For example, “I need a complex SQL script developed for a process.” Experiences gained 324 includes experience post 1810, experience marketplace 1820, available experiences 1821, pending experiences 1822, completed experiences 1823, experience request 1830, experience work 1840, and feedback rating 1850.

Experience post 1810 is the process of a user posting an experience (task) to the Experience marketplace 1820. Characteristics of an experience include: description, skills required/necessary, estimated time, due date, and any other related attributes. For example, “I need a complex SQL script developed for a process.”

Experience marketplace 1820 is the central location of experiences (tasks) in the career management platform 130.

Available experiences 1821 are all the open or available experiences (tasks) that have been posted by users that need to be completed by other users.

Pending experiences 1822 are all the experiences (tasks) that have been assigned a user to complete.

Completed experiences 1823 are all the experiences (tasks) that have been completed by users.

Experience request 1830 is the process in which a user requests to complete an experience listed in Available Experiences 1821. The user who posted the available experience will then accept or reject the request.

Experience work 1840 is the process of submitting a finished experience (task) back to the user who posted it for approval and acceptance.

Feedback rating 1850 is the feedback, rating, and other comments provided to the user who completed the experience (task) from the user who posted the experience (task).

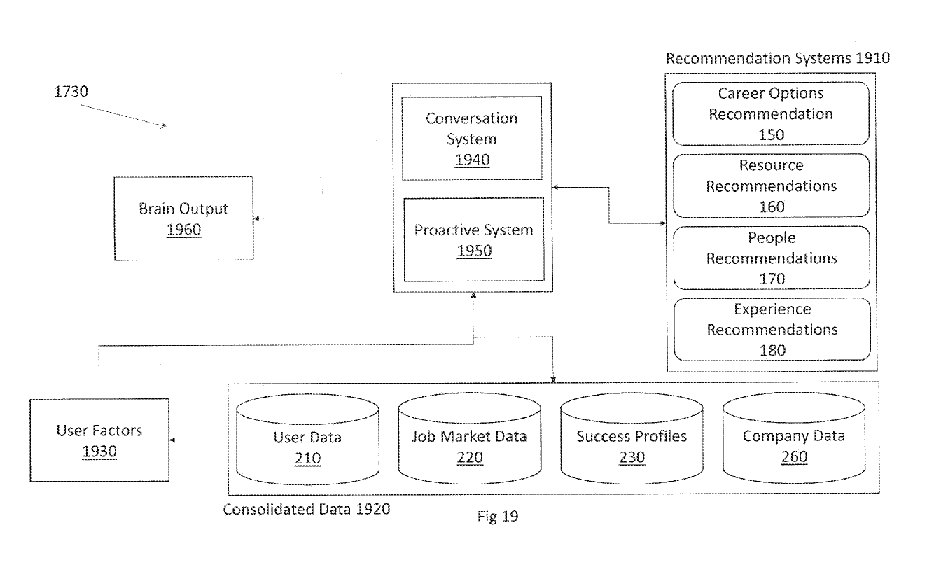

FIG. 19 shows an exemplary interactive brain 1730 that details the artificial intelligence that interacts with users through the user interface 140. Interactive brain 1730 includes recommendation systems 1910, consolidated data 1920, user factors 1930, conversation system 1940, proactive system 1950, and brain output 1960.

Recommendation systems 1910 is all the recommendation systems, it includes career options recommendations 150, resource recommendations 160, people recommendations 170, and experience recommendations 180.

Consolidated data 1920 is all the data in the system, it includes user data 210, job market data 220, success profiles, 230, and company data 260.

User factors 1930 are characteristics that are considered about the user, for example, how active they are on the platform, what they do on the platform, user career goals, user purpose, etc.

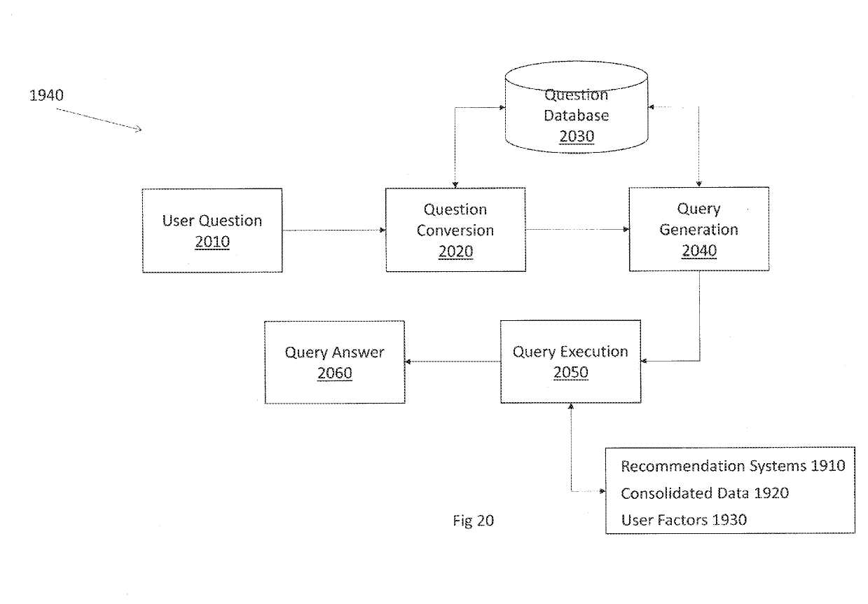

Conversation system 1940 (see FIG. 20) is the system that translates user inquiries using artificial intelligence and then queries the Recommendation Systems 1910 and/or Consolidated Data 1920, and provides an answer, referred to as Brain Output 1960

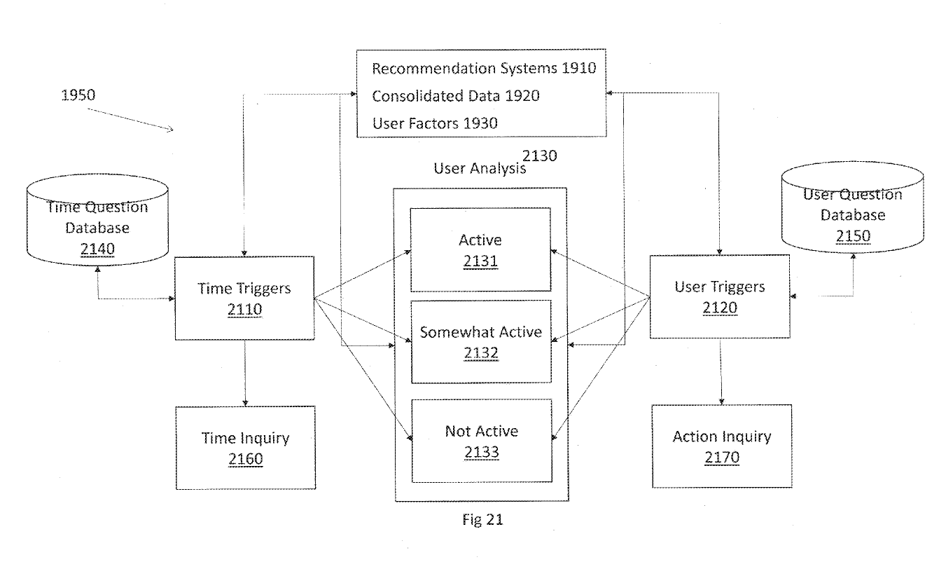

Proactive system 1950 (see FIG. 21) is a system that sends automatic inquiries to users to collect data and improve recommendations. The automatic inquiries are sent out dependent upon user factors 1930.

Brain output 1960 is the result of the conversation system 1940 and/or proactive system 1950 that is sent to the user.

FIG. 20 shows an exemplary conversation system 1940 that details questions asked by users through the conversational ui 1720. Conversation system 1940 includes user question 2010, question conversion 2020, question database 2030, query generation 2040, query execution 2050, recommendation systems 1910, consolidated data 1920, user factors 1930, and query answer 2060.

User question 2010 is a user inquiry in the form of a question sent through the user q & a 1750.

Question conversion 2020 is the process of taking a user question 2010 and converting it using semantic and text analysis, to a normalized question that is recognized in the question database 2030.

Question database 2030 is a database of possible questions to help with the process of converting a user question 2010.

Query generation 2040 is the process of taking the normalized question from the database and generating the appropriate query for the necessary system(s) to understand.

Query execution 2050 is the process of running the query from query generation 2040 in the appropriate system(s) to obtain the query answer 2060.

Query answer 2060 is the answer to the user question 2010 that is to be given back to the user.

FIG. 21 shows an exemplary proactive system 1950 that details automatic inquiries sent to the user from the career management system 130 with the purpose of reengaging the user, data collection, user recommendation improvement, etc. Proactive system 1950 includes time triggers 2110, user triggers 2120, user analysis 2130, active 2131, somewhat active 2132, not active 2133, recommendation systems 1910, consolidated data 1920, user factors 1930, time question database 2140, user question database 2150, time inquiry 2160, and action inquiry 2170.

Time triggers 2110 are triggers based off of time (e.g. daily, weekly). Once a trigger is initiated, it will grab a question or inquiry from the Time question database 2140 dependent upon user analysis 2130, recommendation systems 1910, consolidated data 1920, and user factors 1930.

User triggers 2110 are triggers based off of user actions, characteristics, or other attributes. For example, a user is heavily searching for new careers. Once a trigger is initiated, it will grab a question or inquiry from the User question database 2150 dependent upon user analysis 2130, recommendation systems 1910, consolidated data 1920, and user factors 1930.

User analysis 2130 is an analysis of how engaged the user is on the platform dependent upon recommendation systems 1910, consolidated data 1920, and user factors 1930.

Active 2131 is a determination that the user is actively engaged dependent on the specific trigger (time triggers 2110 or user triggers 2120) according to recommendation systems 1910, consolidated data 1920, and user factors 1930.

Somewhat active 2131 is a determination that the user is somewhat actively engaged, but not unengaged or disengaged dependent on the specific trigger (time triggers 2110 or user triggers 2120) according to recommendation systems 1910, consolidated data 1920, and user factors 1930.

Not active 2132 is a determination that the user is unengaged or disengaged dependent on the specific trigger (time triggers 2110 or user triggers 2120) according to recommendation systems 1910, consolidated data 1920, and user factors 1930.

Time question database 2140 is a database or repository of questions or inquiries related to time to present to users. For example, “you spent most your time last week on researching SQL, are you interested in learning more about this?”.

User question database 2150 is a database or repository of questions or inquiries related to users to present to users. For example, “a new job opening has been posted for a position your following, are you interested in learning more?”.

Time inquiry 2160 is the question selected from the time question database 2140 that is sent to the user. For example, “you spent most your time last week on researching SQL, are you interested in learning more about this?”.

Action inquiry 2170 is the question selected from the user question database 2150 that is sent to the user. For example, “a new job opening has been posted for a position you're following, are you interested in learning more?”

FIG. 22 shows an exemplary flow chart for the career options recommendation, according to some embodiments. FIG. 22 shows an exemplary algorithm of FIG. 2, an exemplary a career options recommendation engine that provides users a list of other career possibilities based upon multiple variables and data, according to some embodiments. At step 2202, all the data from the server according to FIG. 2 may be received. At step 2204, a skill list 630 and user experiences 650 may be compiled. At step 2206, all jobs data 530 may be queried, At step 2208, a list of the jobs with the most possible combination of skills and experiences 640 that are mapped to both may be compiled. For example, SQL Database Developer has 3 of the skills in the skill list 630 and 3 of the experiences in the user experiences 650 for a total of 6. The list is then reduced further by querying and matching other attributes 670, e.g. other direct user inputs 660, at step 2212. For example, does SQL Database Developer match the users preferences 315 (step 2214), personality 314 (step 2216), interests 313 (step 2218), and purpose 316 (step 2220)? If yes, at step 2222, then the job may be included in the final list of career options 250.

FIG. 23 shows an exemplary flow chart for the resources recommendation, according to some embodiments. FIG. 23 shows an exemplary detailed algorithm of FIG. 13, a detailed exemplary process curating resources for users, referred to as the resource recommendations engine. At step 2302, user data 210 may be obtained from the server. The resource recommendation engine may be initiated in two ways: manual or automatic. Manual is where the user can input a term, sentence, or statement into the resource search 1310 (step 2304). Automatic is where the system recognizes the task the user is currently doing 1310 (e.g., on their computers) (step 2306). At step 2308, by using semantic analysis, the system may break the input down into an array of key terms to be used in searching the resources. At step 2310, the resources library 1320 may be queried with the array of key terms. At step 2312, a list of recommended resources with detailed information 1340 may be compiled.

FIG. 24 shows an exemplary flow chart for the experiences recommendation, according to some embodiments. FIG. 24 shows an exemplary detailed algorithm of the experiences recommendations 180, an exemplary recommendation engine that provides users a list of other experiences possibilities based upon multiple variables and data, according to some embodiments. At step 2402, the user data 210 may be obtained from the server. At step 2404, user's purpose 316 may be examined or reviewed if the purpose exists. At step 2406, by using semantic analysis, the user's purpose 316 may be broken down into an array of key terms. At step 2408, whether there is any indication of a desired career change, advancement, or destination may be determined. At step 2410, if there is an indication of a desired career change, advancement, or destination, a user's followed jobs 840 may be compiled. At step 2412, from the user's followed jobs 840, a list of the user experiences 650, skill gaps 1130 and 1140 and the user skills 630 may be compiled. Next, at step 2416, the available experiences 1821 (e.g., experience post 1810, work experience 311, and experience gained 324) may be queried and a list of the ones with the most possible combination of skills and experiences that are mapped to both may be compiled. At step 2418, user experience recommendation may be compiled. At step 2414, if there is no indication of a desired career change, advancement, or destination, user's skill list 630 and user experiences 650 may be compiled. Next, at step 2416, the available experiences 1821 (e.g., experience post 1810, work experience 311, and experience gained 324) may be queried and a list of the ones with the most possible combination of skills and experiences that are mapped to both may be compiled. At step 2418, user experience recommendations 180 may be compiled.

For example, the experience: “mapping data with SQL” requires 6 skills and the user had 5 of the 6 skills in their compiled list (630, 1130, 1140). In addition, the experience is similar to 2 of the experiences in user experiences 650 list. This list will then be sorted by number of skills and become the user experience recommendations 180. If there is no indication of a desired career change, advancement, or destination then it will start to compile only user's skills 630. Next, it will query the available experiences 1821 and compile a list of the ones with the most possible combination of skills and experiences that are mapped to both. For example, the experience: “mapping data with SQL” requires 6 skills and the user had 5 of the 6 skills in their compiled list (only 630). In addition, the experience is similar to 2 of the experiences in user experiences 650 list. This list will then be sorted by number of skills and become the user experience recommendations 180.

In some examples, the career management platform is a platform provided by Patheer, Inc. of Quincy, Mass.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of nonvolatile memory, including by way of example semiconductor memory devices, (e.g., EPROM, EEPROM, and flash memory devices); magnetic disks, (e.g., internal hard disks or removable disks); magneto optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The subject matter described herein can be implemented in a computing system that includes a back end component (e.g., a data server), a middleware component (e.g., an application server), or a front end component (e.g., a client computer having a graphical user interface or a web browser through which a user can interact with an implementation of the subject matter described herein), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

1. A system for facilitating career, skill, and experience management such that a career recommendation can be automatically recommended to a user, the system comprising one or more computer processors executing instructions configured to cause the one or more processors to:
store, in a database in communication with the one or more processors, data indicative of:
at least one skill that a user has obtained; and
at least one experience that the user has obtained;
receive a statement of the user, wherein the statement comprises an objective that the user wants to achieve;
determine, using a semantic analysis, that the statement comprises a goal of the user to improve a skill, an experience, or both, wherein the semantic analysis comprises decomposing the statement into one or more search terms;
query the at least one skill that the user has obtained, the at least one experience that the user has obtained, or both; and
determine a recommendation in response to the user's goal, wherein the recommendation is determined based on the at least one skill that the user has obtained, the at least one experience that the user has obtained, or both; and
provide the recommendation to the user.

2. A system according to claim 1, wherein the one or more processors are further configured to:
determine that the statement comprises a user's desire for a career advancement;
identify a job that the user follows;
identify a gap between:
skills and experiences desired by the job; and
skills and experiences that the user has obtained; and
provide a recommendation to the user's desire based at least partially on the identified gap.

3. A system for facilitating career, skill, and experience management, comprising one or more computer processors executing instructions configured to cause the one or more processors to:
store, in a database in communication with the one or more processors, data indicative of:
at least one skill that a user has obtained;
at least one experience that the user has obtained; and
at least a job has been posted to the system;
extract, via a parser, a skill, an experience, or both, desired by the job;
determine that the job matches the at least one skill that a user has obtained, the at least one experience that the user has obtained, or both; and
recommend the job to the user.

4. The system according to claim 3, wherein the one or more processors are further configured to:
determine that the job matches at least one of a preference of the user, a personality of the user, an interest of the user, a purpose of the user, or any combination thereof.

5. A method for facilitating career, skill, and experience management such that a career recommendation can be automatically recommended to a user, comprising:
storing, in a database, data indicative of:
at least one skill that a user has obtained; and
at least one experience that the user has obtained;
receiving a statement of the user, wherein the statement comprises an objective that the user wants to achieve;
determining, using a semantic analysis, that the statement comprises a goal of the user to improve a skill, an experience, or both, wherein the semantic analysis comprises decomposing the statement into one or more search terms;
querying the at least one skill that the user has obtained, the at least one experience that the user has obtained, or both; and
determining a recommendation in response to the user's goal, wherein the recommendation is determined based on the at least one skill that the user has obtained, the at least one experience that the user has obtained, or both; and
providing the recommendation to the user.

6. A method according to claim 5, further comprising:
determining that the statement comprises a user's desire for a career advancement;
identifying a job that the user follows;
identifying a gap between:
skills and experiences desired by the job; and
skills and experiences that the user has obtained; and
providing a recommendation to the user's desire based at least partially on the identified gap.
